(19) United States
(12) Patent Application Publication
(10) Pub. No.: US 2025/0117194 A1
(43) Pub. Date: Apr. 10, 2025

(54) CUSTOM INTERPRETER FOR EXECUTING COMPUTER CODE GENERATED BY A LARGE LANGUAGE MODEL

(71) Applicant: Dropbox, Inc., San Francisco, CA (US)

(72) Inventor: James Johnson, San Diego, CA (US)

(21) Appl. No.: 18/482,715

(22) Filed: Oct. 6, 2023

(51) Int. Cl. G06F 8/35; G06F 40/20

(52) U.S. Cl. CPC G06F 8/35; G06F 40/20

(57) ABSTRACT

The present disclosure is directed toward systems, methods, and non-transitory computer-readable media for generating context engine outputs by utilizing an interpreter purpose-built to execute code generated by large language models. For example, the disclosed systems generate computer code executable for responding to a query by utilizing a large language model. In addition, the disclosed systems execute the model-generated computer code utilizing an interpreter integrated with the context engine that further includes swappable logic interchangeable across multiple executors. Moreover, the disclosed systems can further generate as part of executing the computer code utilizing the interpreter, a first context engine output by implementing the interpreter at a first executor. Additionally, the disclosed systems can further generate a second context engine output by implementing the interpreter at a second executor.

### BACKGROUND

Advancements in computing devices and networking technology have given rise to a variety of innovations in machine learning and computer architecture. For example, local and web-based computing systems have developed that utilize or implement computer code interpreters for executing computer code to produce a result from a program coded in a computer language. Some existing interpreters can perform a variety of functions and are adaptable to a variety of functions or programs written in their respectively compatible computer languages. Despite these advances, however, existing interpreters continue to suffer from a number of disadvantages, particularly in terms of security, efficiency, and flexibility.

As just suggested, certain existing computer code interpreters are insecure. More particularly, some interpreters predefine types upfront when executing computer programs, exposing potentially large amounts of data-including object definitions and function definitions—in advance of any operation calling the data during execution. As a result of defining types upfront in this fashion, certain interpreters expose the type data as part of initialization and before execution, thereby risking dissemination of sensitive data and/or performance of insecure operations. Such insecure operations include impermissible reads, writes, and deletes of content items, as well as various network operations and creation of new subprocesses by downstream models or systems. Not only does this upfront type configuration result in security issues, but performing type checks solely upfront also introduces stability issues in cases where a computer program calls a function or an object which does not exist in the predefined types (but which nevertheless passed the initial check), which can result in crashes and other stability issues.

In addition to their security issues, existing computer code interpreters are also inefficient. More particularly, due to the standard paradigm of fully defining types upfront, some existing interpreters expend or utilize large amounts of computing resources (e.g., processing power and memory) that could otherwise be preserved with a more efficient interpreter. For instance, existing interpreters often require compiling and recompiling code for each new update or change (to types or other portions of code) because, when types are fully featured upon initialization, the interpreter has no way of knowing which changes actually impact functions or objects called in a particular code segment of a computer program.

Due at least in part to their fully featured nature, existing interpreters further suffer from inflexibility. Indeed, as suggested, certain existing interpreters are rigidly fixed to defining types upfront and thus spin up resources for at least some defined types that are never even called by computer code during execution. Indeed, their inflexible nature prevents many existing interpreters from adapting types on an as-needed basis, further exacerbating their inefficient use of computer resources.

### SUMMARY

This disclosure describes one or more embodiments of systems, methods, and non-transitory computer-readable storage media that provide benefits and/or solve one or more of the foregoing and other problems in the art. For instance, the disclosed systems execute computer code utilizing a custom interpreter purpose-built to run code generated by neural networks, especially large language models. In some cases, the disclosed systems generate computer code utilizing a context engine in conjunction with a large language model. For example, the disclosed systems utilize a context engine and a large language model to generate computer code for performing a particular operation or program which is executed or carried out by the interpreter. In particular, the disclosed systems define and implement a custom interpreter tailored for code generated from large language models through integration of specific features, including pre-runtime and runtime type checking, swappable logic, and state persistence.

### BRIEF DESCRIPTION OF THE DRAWINGS

This disclosure will describe one or more example implementations of the systems and methods with additional specificity and detail by referencing the accompanying figures. The following paragraphs briefly describe those figures, in which:

FIG. 1 illustrates a schematic diagram of an example environment of a custom interpreter system in accordance with one or more embodiments;

FIG. 2 illustrates an example overview of the custom interpreter system utilizing an interpreter to generate a context engine output in accordance with one or more embodiments;

FIG. 3 illustrates an example diagram for the custom interpreter system performing static type checking and dynamic type checking in accordance with one or more embodiments;

FIG. 4 illustrates an example diagram of the custom interpreter system utilizing multiple endpoints to execute computer code in accordance with one or more embodiments;

FIG. 5 illustrates an example diagram of the custom interpreter system persisting a state of the interpreter in accordance with one or more embodiments;

FIG. 6 illustrates an example diagram of the custom interpreter system resuming a state in accordance with one or more embodiments;

FIG. 7 illustrates an example diagram of the custom interpreter system receiving multiple iterative interactions from a client device in accordance with one or more embodiments;

FIG. 8 illustrates an example diagram of the custom interpreter system modifying or generating additional computer code in accordance with one or more embodiments;

FIG. 9 illustrates an example diagram of the custom interpreter system generating a code execution error in accordance with one or more embodiments;

FIGS. 10A-10B illustrate an example graphical user interface of the custom interpreter system receiving an input query and generating an output response in accordance with one or more embodiments;

FIG. 11 illustrates an example series of acts performed by the custom interpreter system in accordance with one or more embodiments;

FIG. 12 illustrates a block diagram of an exemplary computing device in accordance with one or more embodiments; and

FIG. 13 illustrates an example environment of a networking system having the custom interpreter system in accordance with one or more embodiments.

### DETAILED DESCRIPTION

This disclosure describes one or more embodiments of a custom interpreter system that can define and implement a custom computer code interpreter that is purpose-built to run or execute processes defined by computer code generated by a large language model. For example, the custom interpreter system executes computer code utilizing an interpreter integrated (or in communication) with a context engine and a large language model. In some scenarios, the custom interpreter system receives a query from a client device in the form of a text prompt. The custom interpreter system processes the text prompt utilizing a context engine to dissect the prompt into a set of individual sub-prompts that are tailored or designed for more accurate processing by a large language model (and whose results combine to form a target output from the initial prompt/query). In addition, the custom interpreter system utilizes the large language model to generate code segments from each of the respective sub-prompts. In turn, the custom interpreter system utilizes the custom interpreter to execute each of the code segments, generating respective outputs which are combinable using the context engine for a target output of the initial prompt/query.

As described in further detail below, the interpreter includes swappable logic that is compatible with, and interchangeable across, multiple different executors or endpoints. For example, the interpreter is swappable for running (and executing computer code) at different target executors or platforms without recompiling or retooling the programming of the interpreter or the body of the computer code. Due to its swappable nature, the interpreter is more efficient that existing un-swappable interpreters which require reprogramming or recoding all or part of the interpreter structure and/or the computer code executed by the interpreter for each individual executor.

In one or more embodiments, the custom interpreter system performs static type checking prior to executing the computer code (e.g., at compile time). For instance, in some embodiments the custom interpreter system defines code types (where the definitions include attributes and/or functions for the type expressions) before runtime. In other words, in some embodiments the custom interpreter system analyzes the text of a program—e.g., its computer code—to verify or determine its compatibility within its context of use. For example, the custom interpreter system utilizes a static type checking process to verify type safety by checking syntax, completeness, compatibility, and other coding definition standards for type expressions identified in the computer code (e.g., in the code segment corresponding to each sub-prompt) as dictated by a respective programming language.

In one or more embodiments, the custom interpreter system performs dynamic runtime type checking. For instance, during the code execution process, the custom interpreter system performs dynamic type checking for type expressions encountered by the interpreter while running various code segments. In some embodiments the custom interpreter performs the runtime type check in addition to the static type check for improved stability. Indeed, by type checking at runtime, the custom interpreter system can identify expressions that are incomplete, improperly defined, that call types which are not defined at all, and/or that include other syntax or context errors as the interpreter analyzes lines of code for execution.

In one or more embodiments, the custom interpreter system further persists states of the interpreter. For example, the custom interpreter system persists or saves interpreter states while running the computer code (e.g., for potentially later resuming the computer code where it left off). In some embodiments, the interpreter persists states for a threshold time (e.g., five minutes, one hour, five days, etc.). In addition, in some embodiments the interpreter calls prior persisted states for interacting with a large language model (e.g., of the context engine) to recall or regenerate past inputs. In some embodiments, by persisting states, the custom interpreter system facilitates generating new code on the fly, where the state of the code up to a point can be saved and new code can be generated and added to it (or the new code can completely replace the saved code). Furthermore, in some embodiments the interpreter utilizes a multiturn function as a result of persisting states, where a user can ask multiple follow up questions one after the other, and the interpreter remembers previous answers and provides further detail with each turn. To persist a state, in some embodiments the custom interpreter system saves or stores memory registry data, a call stack, and/or an instruction pointer indicating what line or portion of a function is being executed at the time of saving.

Moreover, in one or more embodiments, the custom interpreter system further performs in-function garbage collection while the interpreter runs code. In particular, the in-function garbage collection assists the interpreter in efficiently freeing up memory mid-function.

As suggested above, the custom interpreter system can provide several improvements or advantages over existing interpreters. For example, the custom interpreter system can provide improved security over many existing interpreters. While some interpreters predefine types upfront and expose potentially large amounts of data, the disclosed interpreter can run computer code in a manner that dynamically exposes types. For example, in some instances the custom interpreter uses layer wrappers to abstract coded expressions and to dynamically expose types during execution, thereby improving security by only exposing type data as types are called in their respective expressions or functions. Moreover, in some embodiments the dynamic exposure of types further improves stability by preventing unknown types from causing crashes due to processors calling types or functions that do not exist.

Furthermore, in some embodiments the disclosed interpreter integrates explicitly defined types to improve security. To illustrate, in some instances the explicitly defined types cause the interpreter to only run computer code that contains the explicitly defined types and to refrain from running code that includes expressions not found in the explicit type definitions. In doing so, the custom interpreter system avoids running code that violates security or privacy protocols (e.g., by preventing a large language model from generating computer code based on type data outside of express coding for such use). In some cases, the disclosed interpreter exposes type data only within their respective expressions or code segments where the types are called, storing the type data in memory during execution of the expression and then removing or overwriting the type data as the execution proceeds to subsequent expressions (as opposed to prior interpreters which store type data longer term when the types are defined outside of wrapped expressions).

In addition to improving upon security of conventional interpreters, in some embodiments the custom interpreter system further improves upon efficiency. Unlike conventional interpreters which generally require fully defining types upfront, in some embodiments the custom interpreter system implements the dynamic exposing of types. For instance, as mentioned above, in some embodiments the dynamic exposing of types assists the interpreter in only exposing a type as it is called by running the computer code. In other words, dynamically exposing types assists the custom interpreter system in not crossing wires and not calling a type not intended to be called. Accordingly, in some embodiments the custom interpreter system utilizes the interpreter with dynamic exposing of types to improve the efficiency of running computer code by requiring fewer resources and obviating the need to store and process everything upfront. Additionally, the disclosed interpreter includes swappable logic which preserves or avoids the computational expense of retooling interpreters for use at different executors. Further, the interpreter utilizes both static and dynamic type checking to improve stability and prevent recompiling code for each new update or change (which may or may not impact certain parts of the code), thereby saving additional computational resources.

Due to at least in part to improving security and efficiency, the custom interpreter system also improves upon operational flexibility. While conventional interpreters are rigidly fixed to defining types upfront and consuming resources for some defined types that are never called by computer code during execution, in some embodiments the custom interpreter system utilizes a dynamic exposure of types by only running computer code that has the explicitly defined types and only exposing types as they are called by the computer code. Accordingly, the custom interpreter system improves operational flexibility by adapting types on the fly as computer code is processed.

As illustrated by the foregoing discussion, the present disclosure utilizes a variety of terms to describe features and benefits of the custom interpreter system. Additional detail is hereafter provided regarding the meaning of these terms as used in this disclosure. As used herein, the term “query” includes or refers to data or a specific model output request in the form of input to search for information within a system and/or to generate information using a large language model. In particular, a query includes a text query which can range from a single order text query to a multi-order text query. For instance, a query such as “who have I spent the most time with this month?” can be broken into multiple subcomponents (and is therefore a multi-order text query). To illustrate, the just-mentioned example includes a subcomponent of (i) determining basic details of the user making the query (ii) all meetings attended by the user in the past month (ii)) all attendees of each meeting in the last month and (iv) other subcomponents to determine a combination of the aforementioned subcomponents (e.g., aggregating results of the first few components and selecting a person that matches the text query). Moreover, in some instances the custom interpreter system extracts data from a query or prompt. Specifically, the custom interpreter system 102 can extract natural language structured programmatic data from a query or prompt. Thus, in some instances the generates computer code (e.g., utilizing the context engine interacting with the large language model) in response to extracting natural language structured programmatic data from a query.

As mentioned above, the custom interpreter system utilizes a context engine. As used herein, the term “context engine” includes or refers to a model (e.g., a machine learning model) that works in conjunction with a large language model to break down text queries into individual prompts and to generate computer code from the prompts. For instance, a context engine determines an order of a text query and breaks the query into a set of first-order prompts. The context engine can further combine outputs generated from each first-order prompt into a context engine output responsive to the initial query. To illustrate, the custom interpreter system utilizes the context engine (e.g., context engine) as described by Rajkumar Janakiraman in U.S. patent application Ser. No. 18/309,496, titled GENERATING MULTI-ORDER TEXT QUERY RESULTS UTILIZING A CONTEXT ORCHESTRATION ENGINE, which is hereby incorporated by reference in its entirety.

Further, in some embodiments the custom interpreter system further executes the computer code at an executor. As used herein, the term “executor” includes a runtime engine that executes computer code on a target platform. For example, the executor can refer to a program or application that includes executing computer code on behalf of the interpreter at a specific endpoint. For instance, the custom interpreter system via the executor implements an interpreter to execute computer code in a specific web browser, device, or operating system (e.g., the executor can execute the computer code at a client device that sent the text query to the custom interpreter system).

As mentioned above, the custom interpreter system utilizes the interpreter which integrates explicitly defined types. For example, in computer programing (e.g., object-oriented programming) a “type” includes a description (in a programming language) of a set of values, operations, or building blocks for organizing and modeling data in a software system. In particular, a defined type can include a coded expression defining the structure and behavior of objects of a specifically defined type. For instance, a type can include attributes (e.g., for example for a file system operations type an attribute can include file location, file type, etc.) and functions (e.g., reading a file, writing, a file, or deleting a file) of code expressions.

As mentioned above, the custom interpreter system generates context engine outputs. As used herein, the term “context engine output” includes an output generated by utilizing a context engine to determine (and combine) data generated by an interpreter executing code generated from a large language model. For example, in some embodiments the context engine output includes functions or operations performed by a large language model, such as accessing an email from an email application, extracting all calendar events for a specific week, sending a message, extracting a file from a content management system, booking a flight, booking a hotel, booking a ridesharing vehicle, and other actions performed by applications.

As mentioned above, the context engine includes or refers to a machine learning model. In one or more embodiments a “machine learning model” includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a “neural network” includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

Along these lines, the custom interpreter system utilizes the context engine to interact with a large language model. As used herein, the term “large language model” includes or refers to one or more neural networks capable of processing natural language text to generate outputs that range from predictive outputs, analyses, or combinations of data within stored content items. In particular, a large language model can include parameters trained (e.g., via deep learning) on large amounts of data to learn patterns and rules of language for summarizing and/or generating digital content. Examples of large language model include BLOOM, Bard AI, ChatGPT, LaMDA, DialoGPT, DropboxGPT, and Dropbox FileGPT.

As mentioned above, the custom interpreter system 102 utilizes an interpreter to run computer code generated by a large language model. As used herein, the term “interpreter” includes or refers to a software or application program that reads and executes computer code (e.g., source code) written in a high-level programming language. For instance, the interpreter can read computer code line by line, statement by statement, or instruction by instruction and can execute the code without converting into machine code. In some cases, an interpreter can also or alternatively translate the computer code into machine code or another representation. Moreover, in some instances the interpreter does not utilize a separate compilation step to run computer code.

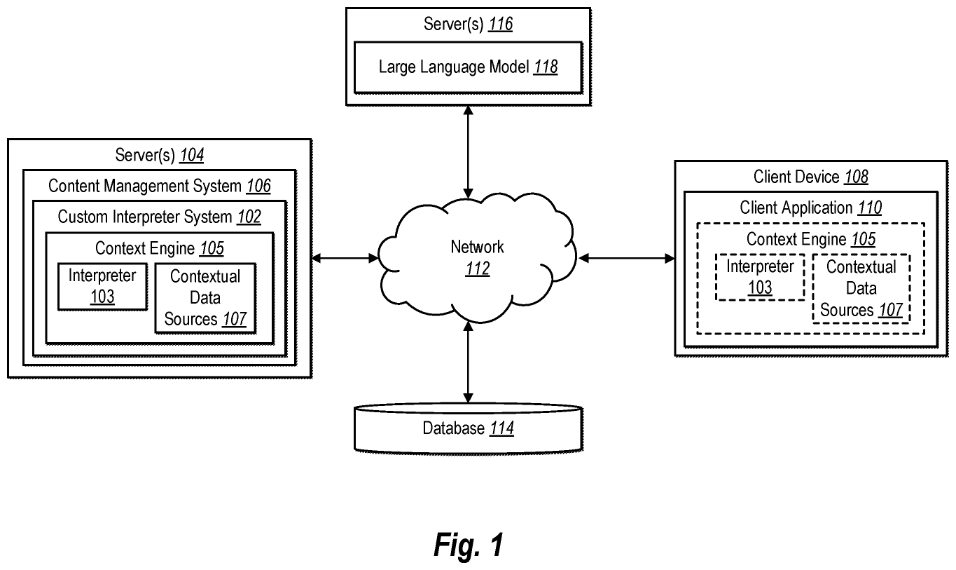

Additional detail regarding the custom interpreter system will now be provided with reference to the figures. For example, FIG. 1 illustrates a schematic diagram of an example system environment for implementing a custom interpreter system 102 in accordance with one or more implementations. An overview of the custom interpreter system 102 is described in relation to FIG. 1. Thereafter, a more detailed description of the components and processes of the custom interpreter system 102 is provided in relation to the subsequent figures.

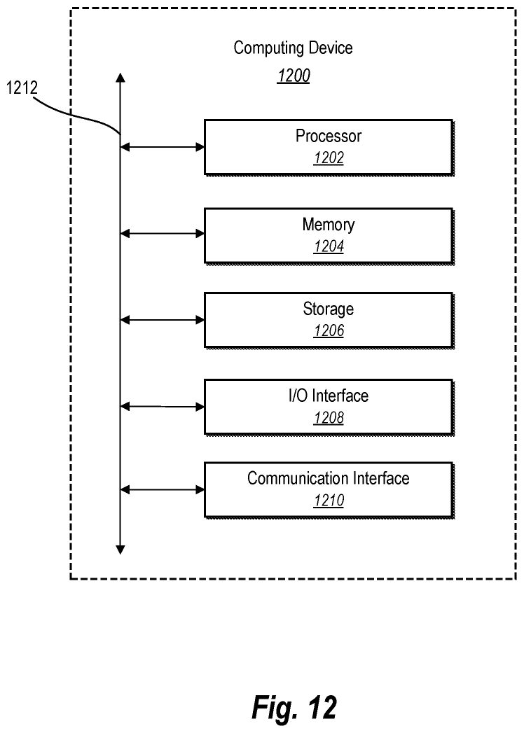

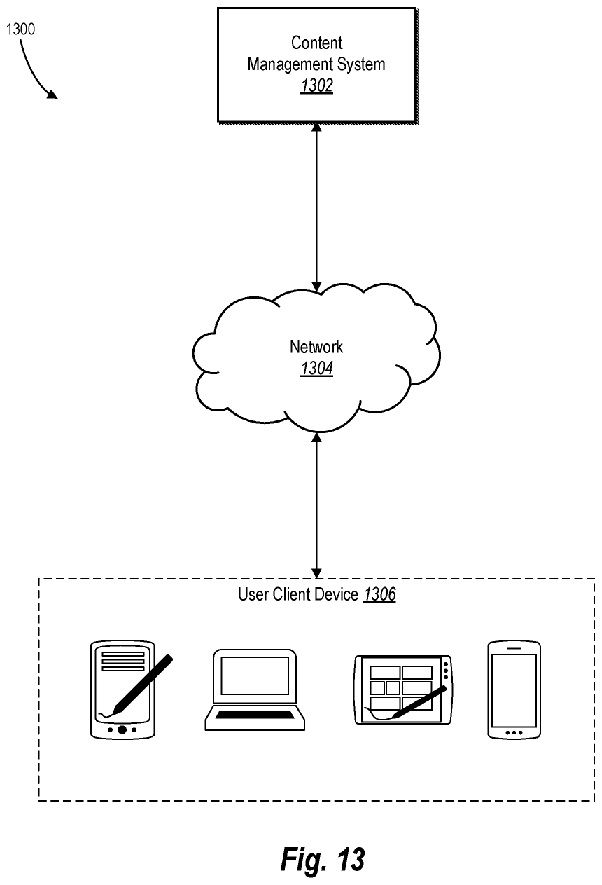

As shown, the environment includes server(s) 104 with the custom interpreter system 102 that includes a context engine 105, which further includes an interpreter 103 and contextual data sources 107, a database 114, server(s) 116, and a client device 108. Each of the components of the environment can communicate via the network 112, and the network 112 may be any suitable network over which computing devices can communicate. Example networks are discussed in more detail below in relation to FIGS. 12-13.

As mentioned above, the example environment includes client device 108. The client device 108 can be one of a variety of computing devices, including a smartphone, a tablet, a smart television, a desktop computer, a laptop computer, a virtual reality device, an augmented reality device, or another computing device as described in relation to FIGS. 12-13. The client device 108 can communicate with the server(s) 104 via the network 112. For example, the client device 108 can receive user input from a user interacting with the client device 108 (e.g., via the client application 110) to, for instance, access, generate, modify, or share a context engine output, or to select user interface elements for interacting with the content management system 106 (e.g., for indicating the contextual data sources 107 or interacting defining text queries). In addition, the custom interpreter system 102 on the server(s) 104 can receive information relating to various interactions with content items and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface for interacting with (or collaborating regarding) generating context engine outputs. Using the client application, the client device 108 can perform (or request to perform) various operations, such as indicating a contextual data source and/or generating a context engine output to a text query.

As illustrated in FIG. 1, the example environment also includes the server(s) 104. The server(s) 104 may generate, track, store, process, receive, and transmit electronic data, such as text queries, context engine outputs, query-component-specific computer code, interactions with interface elements, and/or interactions between user accounts or client devices. For example, the server(s) 104 may receive an indication from the client device 108 of a user interaction defining a text query. In addition, the server(s) 104 can transmit data to the client device 108 in the form of a context engine output to a text query. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, container orchestration servers, communication servers, web-hosting servers, machine learning server, and other types of servers.

As shown in FIG. 1, the server(s) 104 can also include the custom interpreter system 102 as part of a content management system 106. The content management system 106 can communicate with the client device 108 to perform various functions associated with the client application 110 such as managing user accounts, defining text queries, and/or designating contextual data sources. Indeed, the content management system 106 can include a network-based smart cloud storage system to manage, store, and maintain content items and related data across numerous user accounts. In some embodiments, the custom interpreter system 102 and/or the content management system 106 utilize the database 114 to store and access information such as content items, contextual data sources, text queries, results for text queries, responses to text queries, and other information related to persisting a state of the interpreter 103.

As further illustrated, the environment includes the server(s) 116 that hosts a large language model 118. In particular, the large language model 118 communicates with the server(s) 104, the client device 108, and/or the database 114. For example, the custom interpreter system 102 provides domain-specific language segments to the large language model 118, where the domain-specific language segments indicate contextual data sources for generating results for various query subcomponents. Indeed, the large language model 118 can include a machine learning model powered by neural networks or other machine learning architectures for generating responses to text queries. For example, the large language model 118 can refer to a ChatGPT model that generates computer-executable code segments for accessing contextual data sources to generate responses for query subcomponents.

Although FIG. 1 depicts the custom interpreter system 102 located on the server(s) 104, in some implementations, the custom interpreter system 102 may be implemented by (e.g., located entirely or in part on) one or more other components of the environment. For example, the custom interpreter system 102 may be implemented by the client device 108 and/or a third-party system. For example, the client device 108 and/or a third-party system can download all or part of the custom interpreter system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the custom interpreter system 102, bypassing the network 112. The environment may also include one or more third-party systems, each corresponding to a different contextual data source of the contextual data sources 107. In addition, the environment can include the database 114 located external to the server(s) 104 (e.g., in communication via the network 112) or located on the server(s) 104 and/or on the client device 108. In some cases, the server(s) 104 and/or the client device 108 can host or house all or part of the large language model 118.

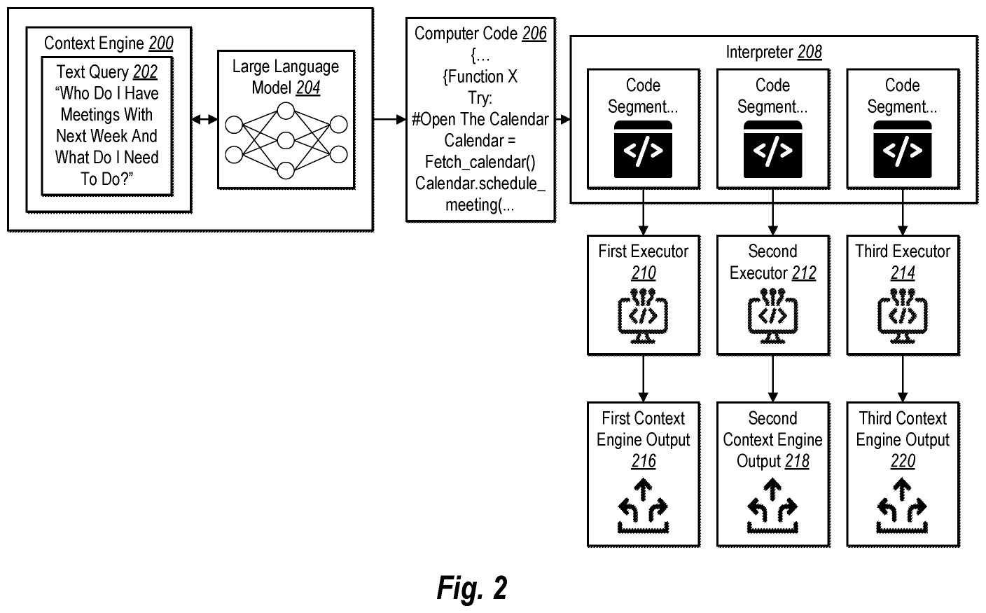

As mentioned above, the custom interpreter system 102 utilizes an interpreter integrated with a context engine to run computer code. FIG. 2 illustrates an overview of the custom interpreter system 102 utilizing an interpreter to generate a context engine output based on receiving a text query in accordance with one or more embodiments.

For example, FIG. 2 shows the custom interpreter system 102 receiving a text query 202 via a context engine 200. To elaborate, the custom interpreter system 102 receives the text query 202 from a client device (e.g., via an interface for interacting with a large language model 204). As shown, the text query 202 in FIG. 2 reads “who do I have meetings with next week and what do I need to do?” As mentioned above, the text query 202 can range from single order text queries to multi-order text queries. Here, the text query 202 shown in FIG. 2 indicates a multi-order text query with subcomponents of (i) calendar data for meetings in the next week (ii) other people that will attend the meeting in the next week, and (iii) tasks associated with each meeting.

Furthermore, FIG. 2 shows the context engine 200 interacting with a large language model 204 to generate the computer code 206. In particular, the context engine 200 receives the text query 202 and in response, generates the computer code 206 from the text query 202. Moreover, in some embodiments, the custom interpreter system 102 utilizes the context engine 200 and the large language model 204 to generate the computer code 206 corresponding to the different subcomponents of the text query 202.

To elaborate on generating the computer code 206, in some cases, the custom interpreter system 102 breaks the text query 202 into individual subcomponents (i), (ii), and (iii) mentioned above. For instance, as described in U.S. patent application Ser. No. 18/309,496 (incorporated above), the custom interpreter system 102 utilizes the context engine 200 to determine how to partition the text query 202 into subcomponents (or lower-order text queries) to provide to the large language model 204. Indeed, the custom interpreter system 102 provides different subcomponents (e.g., (i), (ii), and (iii) mentioned above) of the text query 202 to the large language model 204. In turn, the large language model 204 processes the constituent queries/prompts of the subcomponents to generate computer code segments corresponding to each of the respective subcomponents. In some cases, the context engine 200 combines the individual code segments into a single code segment corresponding to the text query 202 (the query from which the subcomponents were split out).

As just mentioned, the custom interpreter system 102 generates the computer code 206 utilizing the context engine 200 and the large language model 204. In some embodiments, the computer code 206 includes a set of instructions written in a programming language that a computing device can interpret and execute to perform a specific task. In particular, the computer code 206 includes a series of statements and functions that execute specific operations. Further, the computer code 206 includes statements written in specific syntax and translatable into machine code to be executed by a computing device. Accordingly, the custom interpreter system 102 generates the computer code 206 for a particular query for a subcomponent from the text query 202 or for the entire text query 202 as a combination of the subcomponents provided to the large language model 204. In some cases, the computer code 206 corresponds to a contextual data source(s) of the text query 202 (e.g., email application, browser history, messaging applications, calendar, file history, file content, etc.). For instance, the custom interpreter system 102 generates the computer code 206 specific to each of the contextual data sources and executable for responding to each subcomponent of the text query 202.

For example, a contextual data sources relate to a location or system that contains data. In particular, contextual data sources include databases, spreadsheets, files, websites, browsers, social-networking platforms, and other sources of structured and unstructured data. For instance, contextual data sources include structured and unstructured data that support various applications utilized on computing devices. Accordingly, contextual data sources can include both internal or external data on an organizational level, a personal level, or an application level.

As shown in FIG. 2, the computer code 206 is represented by pseudocode that indicates a function of utilizing an application programming interface (API) call to extract data from a calendar application and using the data from the calendar application as input data. Further, FIG. 2 shows the custom interpreter system 102 passing the computer code 206 from the large language model 204 (and/or the context engine 200) to the interpreter 208. For instance, FIG. 2 shows different code segments of the computer code 206 within the interpreter 208. In certain cases, the individual code segments correspond to respective subcomponents split out from the text query 202 (e.g., where a code segment for each subcomponent is generated by the large language model 204 and passed to the interpreter 208). In some embodiments, the code segments represent different portions of computer code designated for execution at different executors or endpoints. Indeed, as shown, the interpreter 208 passes the different code segments to multiple executors. Specifically, FIG. 2 shows the custom interpreter system 102 utilizing the interpreter 208 to pass a code segment to a first executor 210, another code segment to a second executor 212 and another code segment to a third executor 214.

As further shown in FIG. 2, the first executor 210 generates a first context engine output 216, the second executor 212 generates a second context engine output 218, and the third executor 214 generates a third context engine output 220. For example, FIG. 2 shows the first executor 210 to the third executor 214 executing code segments that in some embodiments include individual programs corresponding to each code segment. In some instances, the code segments make up a single program rather than multiple programs. Moreover, in some embodiments each of the context engine outputs shown in FIG. 2 are a result of executing the code segment at a respective executor.

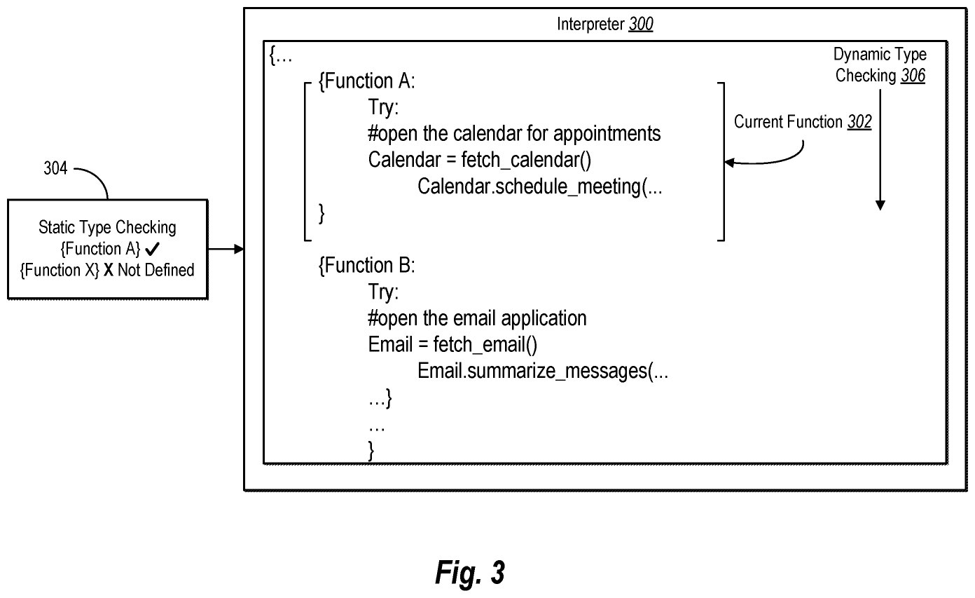

As mentioned above, the custom interpreter system 102 utilizes the interpreter to perform both static and dynamic type checking. FIG. 3 illustrates additional details regarding static and dynamic checking of the custom interpreter system 102 in accordance with one or more embodiments. For example, FIG. 3 shows an interpreter 300 that executes computer code generated from a context engine interacting with a large language model (discussed above).

As mentioned above, in some embodiments the custom interpreter system 102 requires explicit definitions of types for code executed by the interpreter 300. For instance, the custom interpreter system 102 utilizes the interpreter 300 to perform type checking both statically before runtime and dynamically at runtime. For example, type checking includes a process of verifying the data type or class of a variable or code expression conforms to an explicitly defined type within the interpreter 300. Further, type checking helps ensure that variables, expressions, and operations are used consistently and correctly for their data types.

In one or more embodiments, the custom interpreter system 102 performs type checking to prevent errors and/or to prevent the violation of security or privacy protocols. In particular, the static type checking 304 and/or the dynamic type checking 306 prevents security problems associated with using fully featured runtime languages (e.g., allowing a large language model to execute unvetted computer code). For instance, in some embodiments the static type checking 304 and/or the dynamic type checking 306 prevents unwanted file system operations such as reading, writing, or deleting data stored for a user account. In some cases, interpreters that are fully featured upfront can perform such file system operations which can compromise data security if such operations are unwanted, unauthorized, or not explicitly coded-such as in cases where a large language model communicates with the interpreter to execute code and perform certain functions and which thus risk the large language model accessing all of the data and functions of the fully defined types as part of performing additional operations. Conversely, the interpreter 300 utilizes the double-layered type checking (and dynamic exposure of type data) to prevent downstream systems or models (e.g., large language models) from instantiating their own instances of file system operations that would otherwise compromise file system data by moving, deleting, renaming, or otherwise altering data not intended for access by the model (and which is not exposed by the interpreter 300). Along these lines, the custom interpreter system 102 also prevents unwanted network operations that involve revealing information related to network monitoring (e.g., internet protocols), security protocols (e.g., firewalls, security patches, etc.), and connectivity (e.g., uploading and downloading data packets).

Further, in some embodiments, the static type checking 304 and/or the dynamic type checking 306 (and/or dynamic type exposure) prevents revealing information related to contextual environment data. For example, contextual environment data includes operating system information (OS), web browser information (e.g., data indicating the browser type) or application information (being used by a device) where code of a program is run, and/or CPU data. Moreover, in some embodiments, the static type checking 304 and/or the dynamic type checking 306 also prevents downstream systems or models (e.g., large language models) from creating unwanted subprocesses. Indeed, for reasons similar to those discussed above in relation to preventing file system operations, the custom interpreter system 102 can prevent a large language model from creating unauthorized subprocesses that are not part expressly defined as part of executed computer code. For example, a subprocess includes a child process created to perform tasks in addition to or separate from the computer code.

As just mentioned, the custom interpreter system 102 performs a static type checking 304 before runtime. In some embodiments the static type checking 304 prevents the interpreter 300 from accessing data outside of the explicitly defined types (e.g., only those types that are explicitly defined can be run by the interpreter). For instance, the static type checking 304 involves checking syntax of type expressions in the computer code, including object definitions, function definitions, and/or other expressions to identify errors. The static type checking 304 can also involve determining available computing resources and/or determining a computing environment for executing defined types. As part of the static type checking 304, the custom interpreter system 102 can determine whether a defined type is compatible with a particular executor (e.g., an executor that will execute the code defining and/or calling the type). As shown, the static type checking 304 includes an indication that function A of the computer code conforms with the explicitly defined types of the code executed by the interpreter 300. The static type checking 304 also indicates that function B fails to conform with the explicitly defined types of the interpreter 300—e.g., it is a function that is not found within the defined types of the computer code. For instance, if a type within the code is refers to a call by an email application which is not compatible with the defined type, then the static type checking 304 identifies that function as invalid (e.g., the interpreter 300 does not run computer code that contains types not defined within the interpreter 300). Moreover, in some instances the static type checking 304 includes the custom interpreter system 102 determining that the computer code run by the interpreter 300 conforms with syntactic rules and other predefined logic standards of a programming language.

Furthermore, in some embodiments the custom interpreter system 102 performs a second type checking process of the computer code at runtime. In some cases, dynamic type checking 306 at runtime also prevents the interpreter 300 from accessing data outside of the explicitly defined types. For instance, the dynamic type checking 306 involves checking syntax of type expressions in the computer code, including object definitions, function definitions, and/or other expressions to identify errors. The dynamic type checking 306 can also involve determining available computing resources and/or determining a computing environment for executing defined types. In some cases, the dynamic type checking 306 involves cross-checking types as they are executed with their definitions as determined via the static type checking 304. As part of the dynamic type checking 306, the custom interpreter system 102 can determine whether a defined type is compatible with a particular executor that is executing code which calls the type and/or prevents a processor from calling undefined types. If the dynamic type checking 306 indicates that the type is incompatible with the executor (or fails a dynamic syntax check or a dynamic resource check), the custom interpreter system 102 terminates the execution of that portion of the code and proceeds with executing other code. As shown, the interpreter 300 is executing a current function 302, and the custom interpreter system 102 performs the dynamic type checking 306 during execution to analyze the lines of code as they are interpreted or executed.

In some embodiments, the custom interpreter system 102 dynamically exposes types defined within code executed by the interpreter 300. For instance, as the interpreter 300 runs through computer code line by line, the custom interpreter system 102 only exposes a defined type if the computer code indicates that defined type. Thus, as opposed to interpreters that expressly and fully define types upfront at the beginning of a computer code segment, the interpreter 300 wraps the type definitions into the code such that the attributes and functions of the types are exposed dynamically at runtime (e.g., as the lines of code are processed for execution). By dynamically exposing types defined within the interpreter, the custom interpreter system 102 prevents accidental exposure of type data (e.g., attributes and/or functions) to executors or other applications that execute programs defined by the computer code (and/or to downstream models such as large language models that use outputs generated by code for further analysis or prediction). Accordingly, the dynamic exposing of types helps control data flow, data security, and data propagation across networking systems, especially in networks that include large language models which might otherwise ingest data and/or perform functions not intended for their use/performance.

To illustrate, the dynamic exposure of types results from layer wrappers. As mentioned, conventional interpreters expressly and fully define types upfront at the beginning of a computer code segment, the interpreter 300 wraps the type definitions into the code. In other words, the custom interpreter system 102 causes the interpreter 300 to wrap definitions or expressions as they are called by the computer code. For example, for computer code that contains five functions, the interpreter 300 does not define types for all five function upfront and then execute the computer code for the functions. Rather, the custom interpreter system 102 utilizes the interpreter 300 to run the computer code, and as the first function is being run, the interpreter 300 calls up the explicitly defined function wrapped within the first function. Moreover, upon completion of running the first function, the custom interpreter system 102 utilizes the interpreter 300 to call up the explicitly defined function indicated by the second function and so forth (overwriting in memory the type data used for each function).

Indeed, as mentioned, in one or more embodiments, the custom interpreter system 102 utilizes the interpreter 300 to prevent downstream models from performing certain tasks. For example, in some instances, the custom interpreter system 102 configures the interpreter 300 (e.g., by explicitly defining attributes and functions for types) to prevent a large language model from performing additional functions and/or accessing additional data that are not part of the explicitly defined types. In some cases, the custom interpreter system 102 prevents the execution of computer code that would activate downstream models to perform unwarranted actions such as deleting certain files, reading certain files, writing files, accessing private account information, accessing a computing environment state, or performing other sub-processes that violate privacy criteria.

For instance, the custom interpreter system 102 utilizes the interpreter 300 to run code which subsequently employs downstream models (e.g., a large language model) to execute certain actions. Accordingly, in such instances, the custom interpreter system 102 prevents downstream models from performing unwanted tasks. To illustrate, in a situation where a malicious attacker has control over a large language model, the interpreter prevents execution of malicious computer code to access private or secure information or to perform unwanted actions.

Furthermore, in one or more embodiments, the custom interpreter system 102 utilizes the interpreter 300 to prevent large language models from generating computer code that analyzes or utilizes type data from computer code, and which could potentially violate security or privacy protocols. Generally, large language models can generate a wide range of outputs utilizing a variety of techniques in response to input data, as the models self-determine which processes and data to use in response to a prompt. To prevent unfettered access to type data by large language models, in some embodiments the custom interpreter system 102 implements explicit defining of types and dynamic exposure of types.

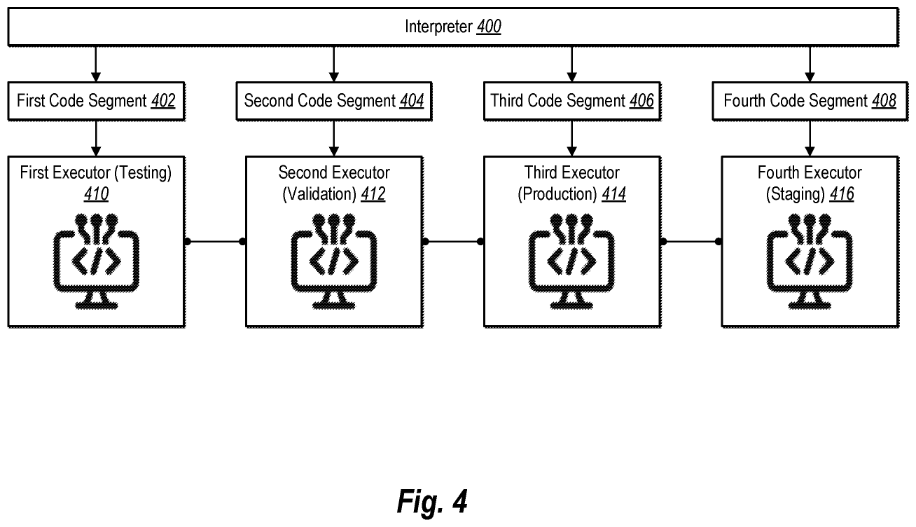

As mentioned previously, the custom interpreter system 102 can execute computer code segments of an interpreter using multiple executors. For example, because the interpreter of the custom interpreter system 102 utilizes (or is made up of) swappable logic, the custom interpreter system 102 can execute computer code interchangeably at different executors without requiring retooling of the interpreter or recoding of the code. FIG. 4 illustrates additional details regarding an interpreter utilizing multiple executors (e.g., endpoints). Particularly, FIG. 4 shows an interpreter passing multiple code segments of computer code to multiple executors in accordance with one or more embodiments.

In some embodiments, the custom interpreter system 102 utilizes the interpreter 400 to run computer code in a host environment (e.g., the runtime environment of a computing device where the interpreter 400 is implemented). Furthermore, in some embodiments, the custom interpreter system 102 utilizes different executors to run different code segments of computer code from the interpreter 400 (and/or to run all of the computer code). As mentioned above, in some embodiments the interpreter 400 includes swappable logic that is interchangeable across multiple executors. In particular, the logic or programming of the interpreter 400 is swappable in that it is cross-compatible for running the same interpreter 400 to execute the same (or different) computer code at different end points or executors. For instance, the interpreter 400 can run the same computer code at a validation executor and at an implementation executor. In some instances, the different executors correspond to various target platforms (e.g., a mobile device, a browser, an application, etc.).

As shown in FIG. 4, the interpreter 400 passes a first code segment 402 to a first executor 410 (testing executor), a second code segment 404 to a second executor 412 (validation executor), a third code segment 406 to a third executor 414 (production executor), and a fourth code segment 408 to a fourth executor 416 (staging executor). Indeed, the interpreter 400 can be run at each of the different executors to execute different code segments (or the same code segment). Further, in one or more embodiments, the custom interpreter system 102 utilizes the interpreter to execute computer code at different endpoints without additional retooling. In other words, the interpreter 400 is swappable to execute computer code at different endpoints without having to reconfigure the interpreter for compatibility at each different endpoint.

For instance, a testing executor can include the process of executing computer code in an environment to identify bugs or defects in the computer code while a validation endpoint can include an environment to determine whether the computer code fulfills its intended purpose. Moreover, a production endpoint can include an environment for executing computer for what an end user would experience, and a staging endpoint can include a demo environment for further testing the computer code.

Moreover, although not shown in FIG. 4, in some embodiments the custom interpreter system 102 utilizes the interpreter 400 to pass each code segment (e.g., first code segment 402 to the fourth code segment 408) to the first executor 410. For instance, the custom interpreter system 102 utilizes the interpreter 400 to pass the computer code (with all the code segments) to each endpoint for execution of the entire computer code at each endpoint. In one or more embodiments, the interpreter 400 translates the source code into machine code or another intermediate representation. As also mentioned above, in some embodiments, because the interpreter 400 directly reads and executes the computer code, the custom interpreter system 102 does not need a separate compilation step. For instance, in some embodiments, the custom interpreter system 102 utilizes the interpreter 400 to run through the computer code line-by-line and converts the computer code into an abstract syntax tree (e.g., a hierarchical data structure that represents the syntactic structure of the computer code).

In some embodiments, from the abstract syntax tree, the custom interpreter system 102 parses, analyzes, and executes the computer code. For instance, the abstract syntax tree represents an intermediate representation of the computer code (e.g., the syntactic structure of the computer code) and guides the interpreter 400 in accurately running the computer code.

Further, in some embodiments the custom interpreter system 102 performs in-function garbage collection. In particular, garbage collection includes reclaiming memory no longer needed by the computer code. For instance, garbage collection includes identifying objects in the computer code no longer referenced by the computer code and releasing the objects from the memory to free up memory allocation. In some embodiments, the custom interpreter system 102 utilizes in-function garbage collection to remove or release stored code of a particular function (or a different function) even while the same function is being executed. In many conventional interpreters, garbage collection is performed after function execution and/or after completion of an entire code segment or program. Indeed, may interpreters are not capable of in-function garbage collection which includes updating the memory as the interpreter 400 runs a function of the computer code. For instance, the custom interpreter system 102 via the interpreter 400 updates the reference count as functions is executed and removes objects no longer referenced.

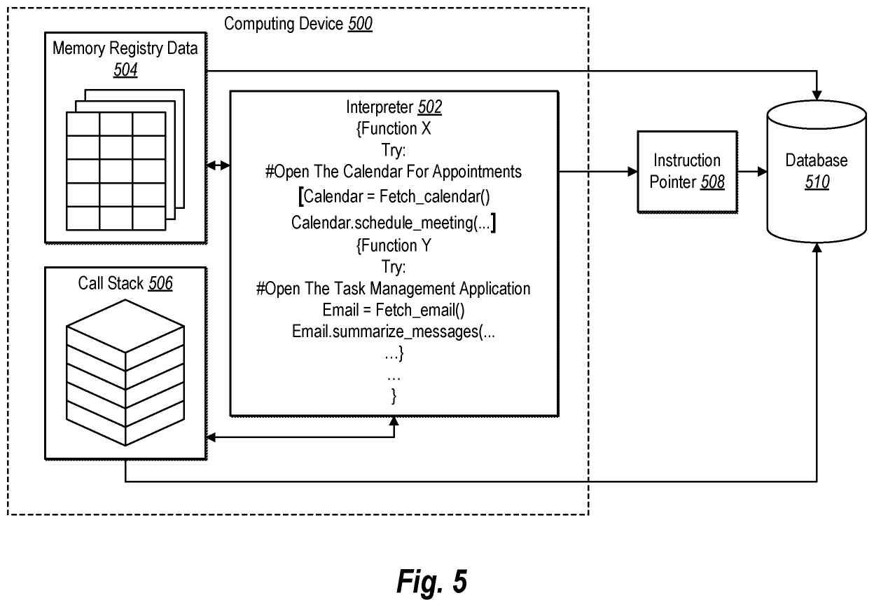

As mentioned above, the custom interpreter system 102 persists a state of the interpreter. FIG. 5 illustrates an example diagram of the custom interpreter system 102 persisting a state of an interpreter in accordance with one or more embodiments. For example, in some embodiments the custom interpreter system 102 persists a state of an interpreter 502 while running computer code. In particular, the custom interpreter system 102 persists the state of the interpreter 502 for a threshold time. In some such embodiments, the custom interpreter system 102 persisting the state of the interpreter 502 allows the interpreter 502 to call prior states used when interacting with a large language model to recall or regenerate past inputs.

Further, in some such embodiments, persisting states further facilitates generating new code on the fly, where the custom interpreter system 102 saves the state of the code and new or modified code is added to the saved code (e.g., code generated by the large language model). Moreover, in some embodiments, persisting states allows for the custom interpreter system 102 to provide multi-turn functionality (e.g., a user can ask multiple follow up questions one after the other, and the interpreter remembers previous answers and provides further detail with each turn).

For example, FIG. 5 shows for the interpreter 502 running computer code, a memory registry data 504. In particular, the memory registry data 504 includes data currently within the interpreter 502 at the time of persisting the state. For instance, the memory registry data 504 includes objects, attributes, or other type data (or other process data) of the computer code in memory at the time of persisting the state. In some embodiments, persisting a state involves saving or storing specific data defining an interpreter state. Such data includes memory registry data, a call stack, and/or an instruction pointer.

Along these lines, FIG. 5 also shows a call stack 506 that corresponds with the interpreter 502 running computer code. In particular, the call stack 506 includes where the interpreter 502 is at in the current scope of a function for the computer code. In particular, the call stack 506 includes a method to manage function calls and the execution of each function call's respective contexts. For instance, the call stack 506 tracks the order of executing functions of the computer code (as the calls are “stacked” in the call stack 506) and maintains information about each function. In some embodiments the call stack 506 works on a last-in, first-out basis. Thus, the call stack 506 oversees high-level functions run by the interpreter 502.

In addition, FIG. 5 shows an instruction pointer 508 that corresponds with the interpreter 502 running computer code. For instance, the custom interpreter system 102 utilizes the instruction pointer 508 to keep track of the address (e.g., a specific reference point) of the next instruction to be executed. In particular, the instruction pointer 508 includes an indication that points to a memory location of a next machine-level instruction to be executed (or a current instruction being executed). In contrast to the call stack 506, the instruction pointer 508 oversees low-level execution of machine instructions within the computer code. As shown, the instruction pointer 508 indicates the particular line of code bookended by bolded square brackets as the current (or next) instruction to process or execute.

As shown in FIG. 5, the custom interpreter system 102 stores the memory registry data 504, the call stack 506, and the instruction pointer 508 within a database 510. In some embodiments the interpreter 502 operates within a computing device 500. For instance, in some embodiments the computing device 500 includes the database 510 while as shown in FIG. 5, in other embodiments the database 510 operates separately from the computing device 500. Accordingly, in some embodiments the custom interpreter system 102 stores the memory registry data 504, the call stack 506, and the instruction pointer 508 in the database 510 to persist a state of the interpreter 502. Thus, the custom interpreter system 102 can save or persist an interpreter state an any instance or moment of code execution for recall in subsequent operations.

In one or more embodiments, the custom interpreter system 102 persists a state of the interpreter 502 for a single session. For instance, a single session can include from the time a user of the client device opens the application to send a text query to the time the user of the client device closes the application. Further, in some embodiments the custom interpreter system 102 persists a state of the interpreter 502 for a set period of time (e.g., a day, an hour, a couple of minutes).

In one or more embodiments, the custom interpreter system 102 saves, persists, stores, or maintains multiple states of the interpreter 502 for a threshold period of time (e.g., hours, days, weeks, or months). For instance, the custom interpreter system 102 saves states within the database 510, and upon a text query containing a word or phrase that calls back to a previous state of the interpreter 502, the custom interpreter system 102 can revert back to the previous state. To illustrate, the custom interpreter system 102 merges saved states together (e.g., from previous conversations between a client device and the custom interpreter system 102) to generate more relevant responses.

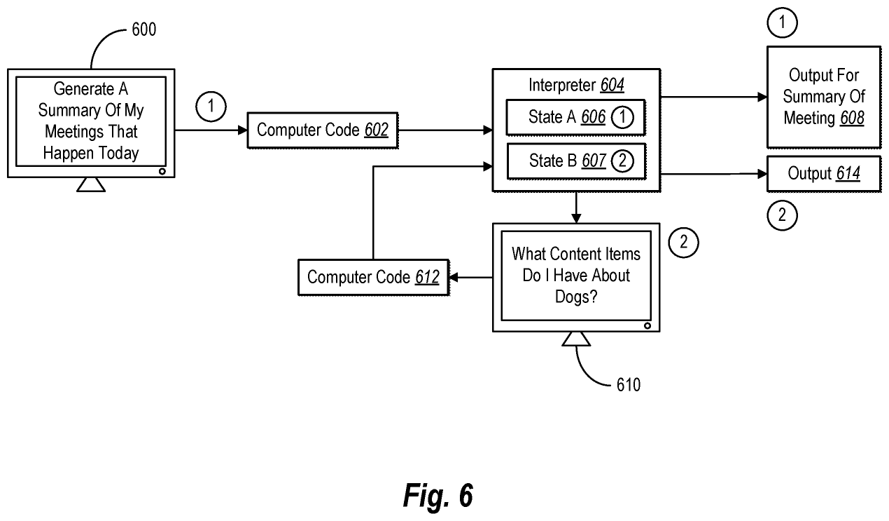

As mentioned above, as a result of persisting a state of an interpreter, the custom interpreter system 102 can recall and resume previous interpreter states. For example, the custom interpreter system 102 can receive a text query from a client device to elaborate or build on a previous state saved for an interpreter, and the custom interpreter system 102 can recall the state and continue generating an output using a large language model and/or a context engine to build on the saved state (rather than starting anew, as required by some interpreters which interact with large language models). FIG. 6 illustrates, an example of the custom interpreter system 102 persisting a state of the interpreter and then resuming the persisted state in accordance with one or more embodiments.

As shown in FIG. 6, the custom interpreter system 102 resumes execution of computer code corresponding to a persisted state by recalling the data stored for the persisted state. For instance, the custom interpreter system 102 obtains from the database the memory registry data, the call stack, and the instruction pointer which indicate where in a computer code segment to resume and which further includes the necessary data for resuming. Further, the custom interpreter system 102 resumes execution of the computer code at the segment indicated by the memory registry data, the call stack, and the instruction pointer.

FIG. 6 shows two paths (represented by a circled number 1 and a circled number 2, respectively). The first path illustrates the custom interpreter system 102 generating an output for a first text query, and the second path illustrates the custom interpreter system 102 generating an output for a second text query that interrupts or breaks the processing of the interpreter 604 when executing the computer code for the first path. As shown in FIG. 6, the custom interpreter system 102 receives a text query 600 that reads “generate a summary of my meetings that happen today.” Further, based on the text query 600, the custom interpreter system 102 generates (e.g., via a content engine and a large language model) computer code 602 for generating an output for the text query 600. The custom interpreter system 102 further utilizes an interpreter 604 to execute or run the computer code 602.

As shown, in some embodiments the custom interpreter system 102 further preserves state A 606 of the interpreter 604. For instance, the interpreter 604 receives the computer code 602 to generate a summary of meeting that happen in the day, and the interpreter 604 runs the computer code 602 until all such meetings are summarized. Thus, in some cases, executing computer code for a single text query can take hours, days, or weeks (or some other time duration) depending on the code of the text query. In some such embodiments, the custom interpreter system 102 persists state A 606 during execution (but before completion) of the computer code 602, as described above in relation to FIG. 5.

In one or more embodiments, the custom interpreter system 102 contains various instances of the interpreter 604 at different server computing devices. For instance, the custom interpreter system 102 handles the first path shown in FIG. 6 (indicated by the circled 1) with a first instance of the interpreter 604 and handles the second path shown in FIG. 6 (indicated by the circled 2) with a second instance of the interpreter 604 (e.g., the custom interpreter system 102 persists different states of the interpreter 604 depending on the interpreter running at different server devices).

As further shown, the custom interpreter system 102 further receives an additional text query 610 that reads “what content items do I have about dogs?” In this instance, the additional text query 610 is completely different from the text query 600 and requires different computer code to generate a response (as determined by a context engine and generated by a large language model). In response to such an interruption query, the custom interpreter system 102 saves or persists state A 606 (and/or persists states at regular intervals). Further, as shown, based on the additional text query 610, the custom interpreter system 102 generates additional computer code 612, and provides the additional computer code 612 to the interpreter 604. As shown in FIG. 6, the second path contains a state B 607 of the interpreter 604, which as mentioned above in some instances indicates a second instance of the interpreter 604. Moreover, in some embodiments, the interpreter 604 runs the additional computer code 612 responsive to the additional text query 610, generates the output 614 for the additional text query 610, and provides the output 614 to the client device which provided the additional text query 610, all while persisting state A 606.

Further, in some embodiments, the custom interpreter system 102 resumes the state A 606 of the interpreter 604 and generates an output 608 for the summary of the meeting that happened that day. For instance, the custom interpreter system 102 resumes the state A 606 of the interpreter 604 in response to completing execution of the computer code 612 which interrupted execution of the computer code 602. Indeed, the custom interpreter system 102 accesses the memory registry data, the call stack, and/or the instruction pointer of the state A 606 to resume executing the computer code 602 at the particular instruction and with the appropriate data.

Although not shown in FIG. 6, in one or more embodiments, the custom interpreter system 102 can continually pause and resume states of the interpreter 604. For instance, for the text query 600, if custom interpreter system 102 receives additional interrupting queries from the client device, the custom interpreter system can generate and execute code for each of the interrupting queries, persist a state of the interpreter 604, and resume the state of the interpreter 604 as the interrupting code is completed.

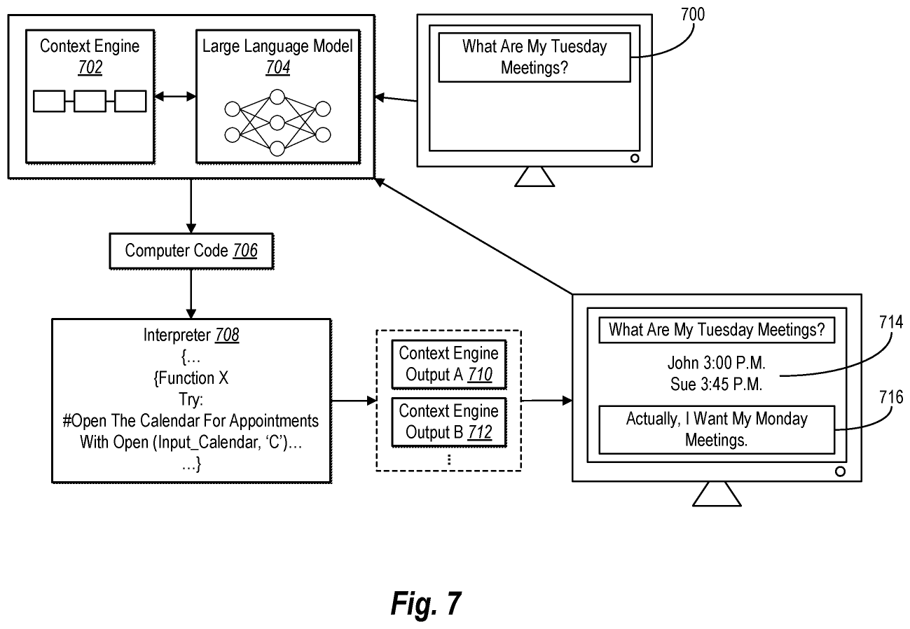

As mentioned above, the custom interpreter system 102 persisting a state of the interpreter further enables multi-turn functionality. FIG. 7 illustrates an example of the custom interpreter system 102 receiving multiple interactions from a client device for a multi-turn function in accordance with one or more embodiments.

For example, FIG. 7 shows an initial text query 700 that reads “what are my Tuesday meetings?” Further, the custom interpreter system 102 utilizes a context engine 702 that interacts with a large language model 704 to receive the initial text query 700 and to generate computer code 706. Moreover, as shown, the custom interpreter system 102 utilizes an interpreter 708 to run the computer code 706.

As shown, based on the interpreter 708 running the computer code 706, the custom interpreter system 102 generates a context engine output A 710. Further, as shown, the context engine output A 710 includes generating a response 714 to the initial text query 700 that includes “John 3:00 p.m. and Sue 3:45 p.m.” Moreover, as shown, the custom interpreter system 102 receives an additional text query 716 that reads “actually, I want my Monday meetings.”

For instance, as shown, the custom interpreter system 102 utilizes the context engine 702 that interacts with the large language model 704 to receive the additional text query 716. As shown, in response to the additional text query 716, the custom interpreter system 102 generates additional computer code and a context engine output B 712 responsive to the additional text query 716. As indicated by the ellipses, the custom interpreter system 102 can generate additional outputs based on additional interactions received from the client device.

In one or more embodiments, the custom interpreter system 102 can receive multiple interactions from a client device due to the custom interpreter system 102 persisting the state of the interpreter 708. Accordingly, the custom interpreter system 102 provides a chat-like functionality for a user of the client device. In particular, with each turn (e.g., interaction from the client device), the custom interpreter system 102 remembers the previous interaction and can merely modify the computer code in response to the additional interaction or generate new computer code based on the initial computer code.

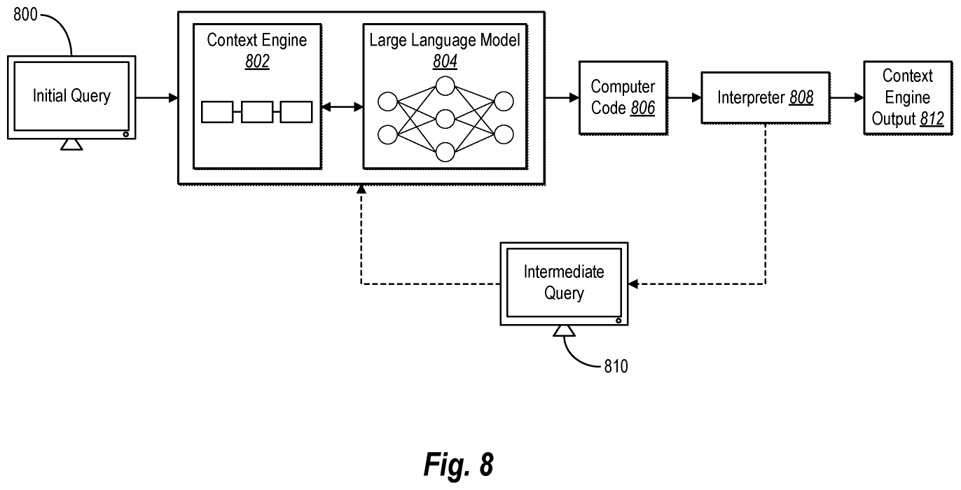

As mentioned above, in some embodiments the custom interpreter system 102 generates modified or new computer code. FIG. 8 illustrates the custom interpreter system 102 generating computer code for a text query and/or modifying computer code in accordance with one or more embodiments.

For example, as shown, the custom interpreter system 102 receives an initial prompt 800 by utilizing a context engine 802 that interacts with a large language model 804. Further, as shown, the custom interpreter system 102 generates computer code 806 responsive to the initial prompt 800 and utilizes an interpreter 808 to run the computer code 806.

In some embodiments, if the custom interpreter system 102 does not receive additional prompts or interactions from the client device, the custom interpreter system 102 utilizes the interpreter 808 to run the computer code 806 and generate a context engine output 812. In some embodiments, the custom interpreter system 102 receives an intermediate query 810 after receiving the initial prompt 800. In response to receiving the intermediate query 810, the custom interpreter system 102 can tweak, alter, or modify the computer code 806 (e.g., via the context engine 802 interacting with the large language model 804) or the custom interpreter system 102 can generate new computer code to replace the computer code 806.

In some embodiments the custom interpreter system 102 determines that some portions of the initially generated computer code are preservable in light of receiving the intermediate query 810. For instance, the custom interpreter system 102 generates, utilizing the context engine 802 to interact with the large language model 804, replacement code for the portions of the computer code that are not preservable (e.g., computer code that corresponds with the intermediate query 810). To illustrate, in some embodiments the example given above in FIG. 7 fits under generating modified computer code and preserving portions of the computer code. For instance, the custom interpreter system 102 determines from the intermediate query 810 that a user of the client device actually wants Monday meetings instead of Tuesday meetings. In some such embodiments, rather than generating completely new computer code, the custom interpreter system 102 generates modified computer code that merely replaces the Tuesday portion with Monday.

Furthermore, in some embodiments, the custom interpreter system 102 determines that no portions of the initially generated computer code are preservable. In some such embodiments, the custom interpreter system 102 generates, utilizing the context engine 802 to interact with the large language model 804, new computer code corresponding to the intermediate query 810 (e.g., to replace the initially generated computer code). Continuing with the example given in FIG. 7, rather than a user of the client device sending the intermediate query 810 that includes replacing Tuesday with Monday, the user queries the custom interpreter system 102 for cat pictures stored on the client device. In some such instances, because the intermediate query 810 is not related to the initial query, the custom interpreter system 102 generates completely new computer code.

As an example, the initial prompt 800 could include “tell me what meetings I have with Jim next week?” The intermediate query 810 (prior to the custom interpreter system 102 generating a response to the initial prompt 800) could include “for my meetings with Jim next week, what do I still need to prepare for?” Accordingly, in response to the intermediate query 810 the custom interpreter system 102 on the fly could modify the computer code 806 to accommodate the intermediate query 810.

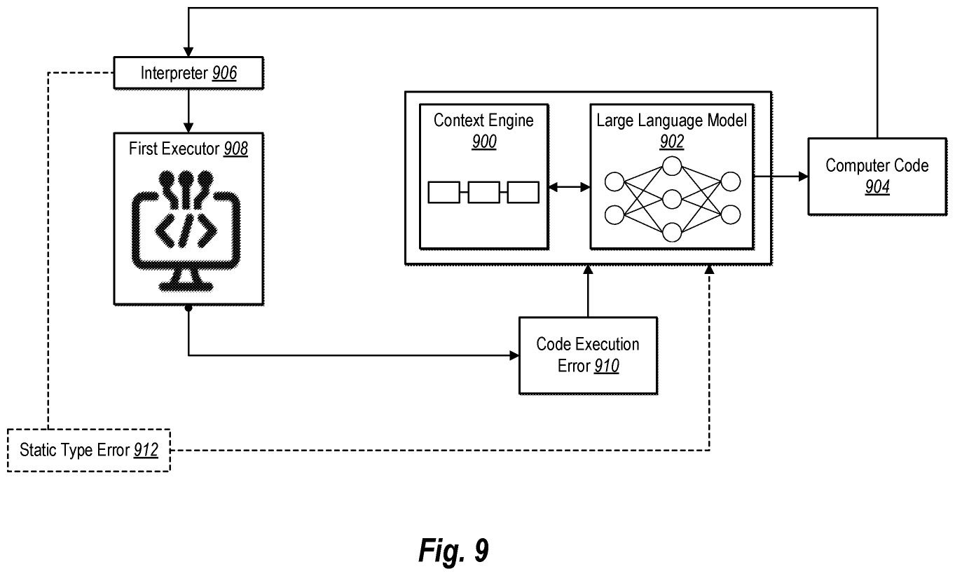

FIG. 9 shows the custom interpreter system 102 generating a code execution error in response to an interpreter running the computer code in accordance with one or more embodiments. For example, FIG. 9 shows the custom interpreter system 102 utilizing a context engine 900 that interacts with a large language model 902 to generate computer code 904.

Further, FIG. 9 shows an interpreter 906 running the computer code 904 at a first executor 908. As shown, in running the computer code 904 at the first executor 908, the custom interpreter system 102 generates a code execution error 910. For instance, the code execution error 910 includes the custom interpreter system 102 utilizing the interpreter 906 to perform a dynamic analysis and determining that the computer code 904 contains types not explicitly defined within the interpreter 906. Further in some instances, the code execution error 910 includes a context engine output.

In one or more embodiments, based on the code execution error 910, the custom interpreter system 102 further utilizes the context engine 900 to generate modified computer code. In some instance, in response to the code execution error 910, the custom interpreter system 102 sends a notification to the client device. Specifically, the notification can include providing an option to a user of the client device to approve the running of the computer code (e.g., despite the computer code including types not explicitly defined in the interpreter 906). To illustrate, the notification could ask the user of the client device to approve sharing a private email message within a public messaging application.

In some embodiments, the custom interpreter system 102 determines a static type error 912. In particular, the static type error 912 includes the custom interpreter system 102 utilizing the interpreter 906 to run the computer code 904 and determine that at pre-runtime, the computer code 904 contains types not explicitly defined within the interpreter 906. Like the code execution error 910, in some embodiments the static type error 912 also causes the custom interpreter system 102 to utilize the context engine 900 to generate modified computer code.

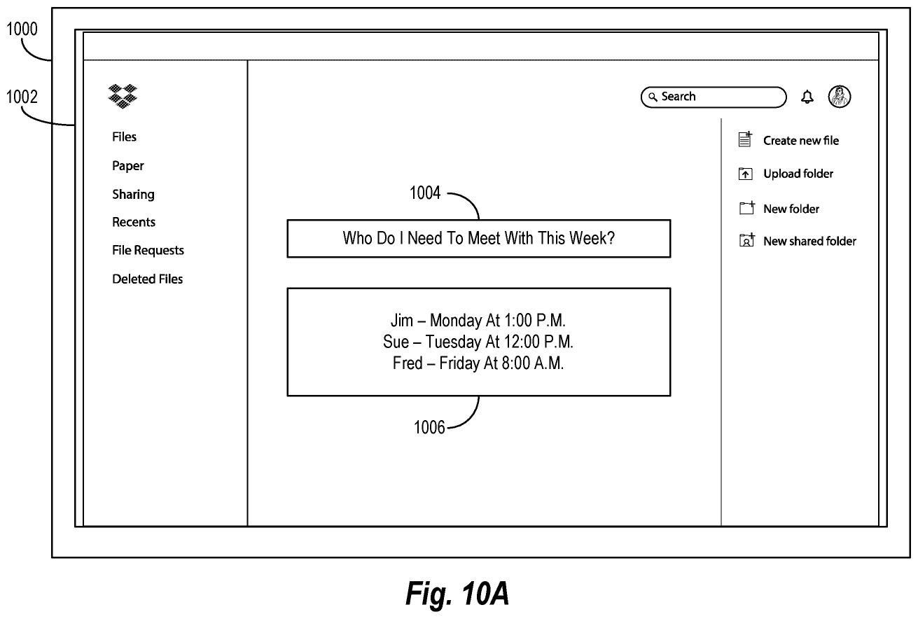

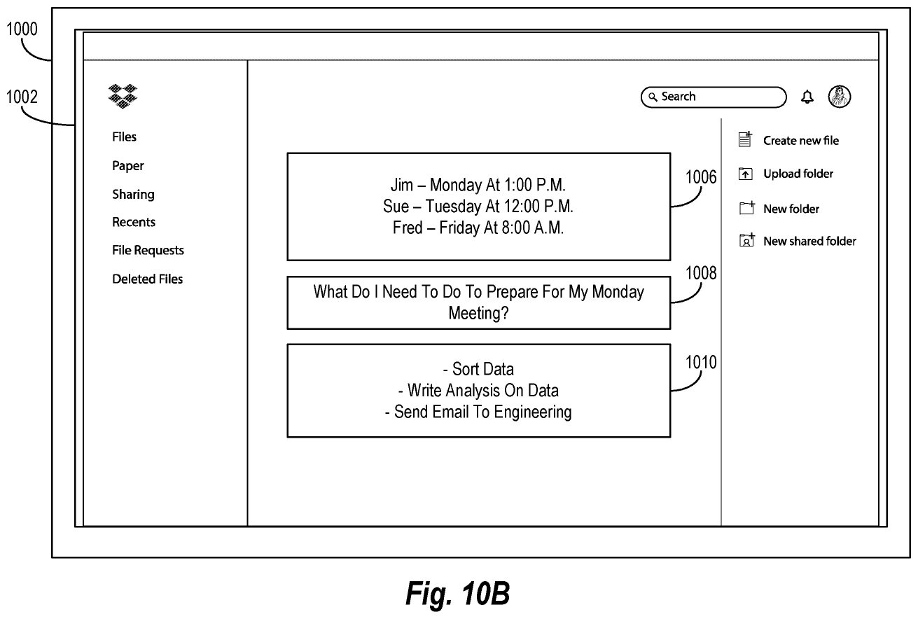

FIG. 10A shows the custom interpreter system 102 operating within a graphical user interface in accordance with one or more embodiments. For example, FIG. 10A shows a client device 1000 with a graphical user interface 1002 (e.g., a DROPBOX homepage). Furthermore, FIG. 10A shows a text query 1004 that reads “who do I need to meet with this week?” In response to a user of the client device 1000 inputting the text query 1004, the custom interpreter system 102 utilizes the methods described above to generate a context engine output 1006 to the text query 1004. In particular, the context engine output 1006 includes “Jim-Monday at 1:00 p.m., Sue-Tuesday at 12:00 p.m., Fred-Friday at 8:00 a.m.”

Moreover, FIG. 10B further shows the custom interpreter system 102 receiving an additional text query. For example, FIG. 10B shows an additional text query 1008 after receiving the context engine output 1006. In particular, the additional text query 1008 reads “what do I need to do to prepare for my Monday meeting?” As shown, the custom interpreter system 102 generates an additional context engine output 1010 that reads “-sort data,-write analysis on data,-send email to engineering.” For instance, as shown in FIG. 10B, the custom interpreter system 102 utilizes state persistence of the interpreter to remember the text query 1004 to generate the additional context engine output 1010.

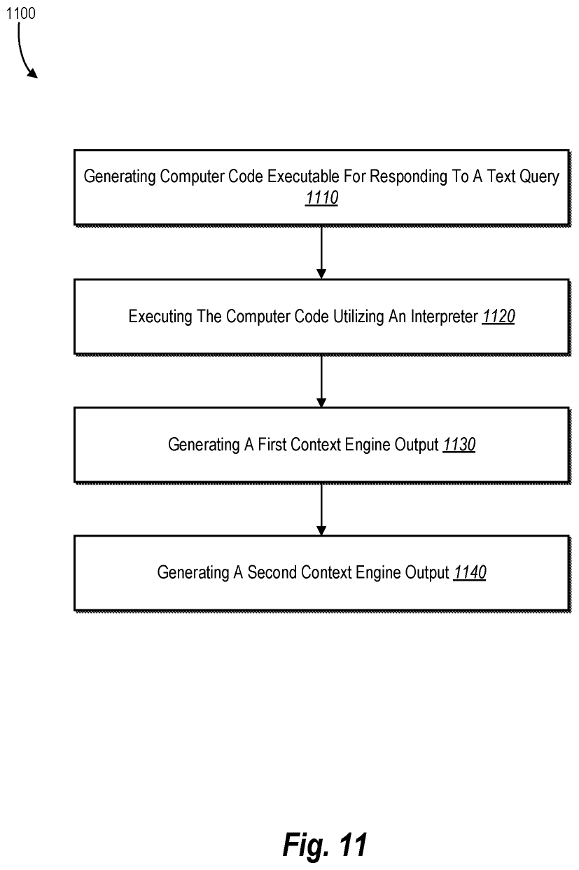

While FIG. 11 illustrates acts according to certain implementations, alternative implementations may omit, add to, reorder, and/or modify any of the acts shown in FIG. 11. The acts of FIG. 11 can be performed as part of a method. Alternatively, a non-transitory computer-readable medium can comprise instructions, that when executed by one or more processors, cause a computing device to perform the acts of FIG. 11. In still further implementations, a system can perform the acts of FIG. 11.

As illustrated in FIG. 11, a series of acts 1100 may include an act 1110 of generating computer code executable for responding to a query, an act 1120 of executing the computer code utilizing an interpreter, an act 1130 of generating a first context engine output, and an act 1140 of generating a second context engine output.

In particular the act 1110 includes in response to a query received from a client device, generating, utilizing a context engine to interact with a large language model, computer code executable for responding to the query. Further, the act 1120 includes executing the computer code utilizing an interpreter integrated with the context engine and comprising swappable logic that is interchangeable across multiple executors. Moreover, the act 1130 includes generating, as part of executing the computer code utilizing the interpreter, a first context engine output by implementing the interpreter to interpret the computer code from the context engine to a first executor. Additionally, the act 1140 includes generating, as part of executing the computer code utilizing the interpreter, a second context engine output by implementing the interpreter to interpret the computer code from the context engine to a second executor.

Further, in one or more embodiments the series of acts 1100 includes utilizing the interpreter that includes explicitly defined types that define attributes and functions of code expressions. Additionally, in one or more embodiments the series of acts 1100 includes preventing the computer code from causing the interpreter to perform file system operations to read, write, or delete data stored for a user account. Moreover, in one or more embodiments the series of acts 1100 includes dynamically exposing types defined within the interpreter that correspond with the computer code.

Furthermore, in one or more embodiments the series of acts 1100 includes utilizing the interpreter to execute the computer code at a first executor for testing. Additionally, in one or more embodiments the series of acts 1100 includes utilizing the interpreter to execute the computer code at a second executor for validation without retooling the interpreter. Moreover, in one or more embodiments the series of acts 1100 includes in response to a first interaction from the client device, generating, utilizing the interpreter, an intermediate context engine output. Further, in one or more embodiments the series of acts 1100 includes receiving a second interaction from the client device. Moreover, in one or more embodiments the series of acts 1100 includes based on the second interaction, generating, utilizing the large language model, a modified context engine output from the intermediate context engine output.

Further, in one or more embodiments the series of acts 1100 includes storing, in a database during execution of the computer code, memory registry data associated with performing a function via the interpreter. Moreover, in one or more embodiments the series of acts 1100 includes storing, in the database, a call stack comprising data defining a computer environment of an executor from among the multiple executors. Additionally, in one or more embodiments the series of acts 1100 includes in response to a state persisting event, storing, in the database, an instruction pointer indicating a segment of the computer code being executed by the interpreter.

Moreover, in one or more embodiments the series of acts 1100 includes obtaining, from the database, the memory registry data, the call stack, and the instruction pointer. Further, in one or more embodiments the series of acts 1100 includes resuming execution of the computer code at the segment indicated by the instruction pointer. Additionally, in one or more embodiments the series of acts 1100 includes in response to a first interaction from the client device, generating, utilizing the interpreter, a first output.

Moreover, in one or more embodiments the series of acts 1100 includes persisting a state of the interpreter corresponding to the first output. Further, in one or more embodiments the series of acts 1100 includes in response to a second interaction from the client device, generating a second output based on persisting the state of interpreter corresponding to the first output. Further, in one or more embodiments, the series of acts 1100 includes performing an in-function garbage collection process as part of executing the computer code.

Furthermore, in one or more embodiments the series of acts 1100 includes in response to a query received from a client device, generating, utilizing a context engine to interact with a large language model, computer code executable for responding to the query. Moreover, in one or more embodiments, the series of acts 1100 includes executing the computer code utilizing an interpreter integrated with the context engine and comprising swappable logic that is interchangeable across multiple executors. Further, in one or more embodiments, the series of acts 1100 includes generating, as part of executing the computer code utilizing the interpreter, a first context engine output by implementing the interpreter to interpret the computer code from the context engine to a first executor for testing. Moreover, in one or more embodiments, the series of acts 1100 includes generating, as part of executing the computer code utilizing the interpreter, a second context engine output by implementing the interpreter to interpret the computer code from the context engine to a second executor for validation.

Moreover, in one or more embodiments the series of acts 1100 includes utilizing the interpreter so that the interpreter cannot process code expressions outside of explicitly defined types that define attributes and functions of code expressions. Further, in one or more embodiments the series of acts 1100 includes utilizing the interpreter to prevent a downstream model from one or more of performing network operations, determining contextual environment data of the first executor and the second executor, or creating new subprocesses. Further, in one or more embodiments, the series of acts 1100 includes exposing called data corresponding to the type as part of executing a function of the computer code that refers to the called data. Moreover, in one or more embodiments, the series of acts 1100 includes not exposing uncalled data corresponding to the type as part of executing the function of the computer code.

Moreover, in one or more embodiments the series of acts 1100 includes storing, in a database during execution of the computer code, memory registry data associated with performing a function via the interpreter. Further, in one or more embodiments the series of acts 1100 includes storing, in the database, a call stack comprising data defining a computer environment of an executor from among the multiple executors. Further, in one or more embodiments, the series of acts 1100 includes in response to a state persisting event, storing, in the database, an instruction pointer indicating a segment of the computer code being executed by the interpreter.

Furthermore, in one or more embodiments the series of acts 1100 includes in response to a query received from a client device, generating, utilizing a context engine to interact with a large language model, computer code executable for responding to the query. Moreover, in one or more embodiments, the series of acts 1100 includes executing the computer code utilizing an interpreter integrated with the context engine and comprising explicitly defined types that define attributes and functions of code expressions and swappable logic that is interchangeable across multiple executors. Further, in one or more embodiments, the series of acts 1100 includes generating, as part of executing the computer code utilizing the interpreter, a first context engine output by implementing the interpreter to interpret the computer code from the context engine to a first executor. Moreover, in one or more embodiments, the series of acts 1100 includes generating, as part of executing the computer code utilizing the interpreter, a second context engine output by implementing the interpreter to interpret the computer code from the context engine to a second executor.

Moreover, in one or more embodiments the series of acts 1100 includes performing a first type checking process before runtime for executing the computer code to prevent the interpreter from accessing data outside of the explicitly defined types. Further, in one or more embodiments the series of acts 1100 includes perform a second type checking process at runtime for executing the computer code to prevent the interpreter from accessing data outside of the explicitly defined types.

Further, in one or more embodiments, the series of acts 1100 includes in response to a first interaction from the client device, generate, utilizing the interpreter, a first output. Moreover, in one or more embodiments the series of acts 1100 includes persisting a state of the interpreter corresponding to the first output. Further, in one or more embodiments the series of acts 1100 includes generating, utilizing the large language model, a second output based on the first output indicated by persisting the state of the interpreter.

The components of the custom interpreter system 102 can include software, hardware, or both. For example, the components of the custom interpreter system 102 can include one or more instructions stored on a computer-readable storage medium and executable by processors of one or more computing devices. When executed by one or more processors, the computer-executable instructions of the custom interpreter system 102 can cause a computing device to perform the methods described herein. Alternatively, the components of the custom interpreter system 102 can comprise hardware, such as a special purpose processing device to perform a certain function or group of functions. Additionally or alternatively, the components of the custom interpreter system 102 can include a combination of computer-executable instructions and hardware.

Furthermore, the components of the custom interpreter system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the custom interpreter system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server(s) 104, the server(s) 116, and/or the client device 108) that may be configured to perform one or more of the processes described above. One will appreciate that server(s) 104 and/or the client device 108 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 is a schematic diagram illustrating environment 1300 within which one or more implementations of the custom interpreter system 102 can be implemented. For example, the custom interpreter system 102 may be part of a content management system 1302 (e.g., the content management system 106). Content management system 1302 may generate, store, manage, receive, and send digital content (such as digital content items). For example, content management system 1302 may send and receive digital content to and from client device of client devices 1306 by way of network 1304. In particular, content management system 1302 can store and manage a collection of digital content. Content management system 1302 can manage the sharing of digital content between computing devices associated with a plurality of users. For instance, content management system 1302 can facilitate a user sharing a digital content with another user of content management system 1302.

In particular, content management system 1302 can manage synchronizing digital content across multiple client devices 1306 associated with one or more users. For example, a user may edit digital content using a client device of the client device 1306. The content management system 1302 can cause client device of the client devices 1306 to send the edited digital content to content management system 1302. Content management system 1302 then synchronizes the edited digital content on one or more additional computing devices.

In addition to synchronizing digital content across multiple devices, one or more implementations of content management system 1302 can provide an efficient storage option for users that have large collections of digital content. For example, content management system 1302 can store a collection of digital content on content management system 1302, while the client device of the client devices 1306 only stores reduced-sized versions of the digital content. A user can navigate and browse the reduced-sized versions (e.g., a thumbnail of a digital image) of the digital content on client device of the client devices 1306. In particular, one way in which a user can experience digital content is to browse the reduced-sized versions of the digital content on client device of client devices 1306.

Another way in which a user can experience digital content is to select a reduced-size version of digital content to request the full- or high-resolution version of digital content from content management system 1302. In particular, upon a user selecting a reduced-sized version of digital content, client device of client devices 1406 sends a request to content management system 1302 requesting the digital content associated with the reduced-sized version of the digital content. Content management system 1302 can respond to the request by sending the digital content to client device of client devices 1306. Client device of client devices 1306, upon receiving the digital content, can then present the digital content to the user. In this way, a user can have access to large collections of digital content while minimizing the amount of resources used on client device of client devices 1306.

client device of client devices 1306 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. client device of client devices 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1304.

Network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client device of client devices 1306 may access content management system 1302.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A computer-implemented method comprising:
in response to a query received from a client device, generating, utilizing a context engine to interact with a large language model, computer code executable for responding to the query;
executing the computer code utilizing an interpreter integrated with the context engine and comprising swappable logic that is interchangeable across multiple executors;
generating, as part of executing the computer code utilizing the interpreter, a first context engine output by implementing the interpreter to interpret the computer code from the context engine to a first executor; and
generating, as part of executing the computer code utilizing the interpreter, a second context engine output by implementing the interpreter to interpret the computer code from the context engine to a second executor.

2. The computer-implemented method of claim 1, wherein the interpreter comprises explicitly defined types that define attributes and functions of code expressions.

3. The computer-implemented method of claim 1, further preventing the computer code from causing the interpreter to perform file system operations to read, write, or delete data stored for a user account.

4. The computer-implemented method of claim 1, wherein executing the computer code utilizing the interpreter further comprises dynamically exposing types defined within the interpreter that correspond with the computer code.

5. The computer-implemented method of claim 1, wherein the swappable logic of the interpreter facilitates:
utilizing the interpreter to execute the computer code at a first executor for testing; and
utilizing the interpreter to execute the computer code at a second executor for validation without retooling the interpreter.

6. The computer-implemented method of claim 1, further comprising:
in response to a first interaction from the client device, generating, utilizing the interpreter, an intermediate context engine output;
receiving a second interaction from the client device; and
based on the second interaction, generating, utilizing the large language model, a modified context engine output from the intermediate context engine output.

7. The computer-implemented method of claim 1, further comprising persisting a state of the interpreter by:
storing, in a database during execution of the computer code, memory registry data associated with performing a function via the interpreter;
storing, in the database, a call stack comprising data defining a computer environment of an executor from among the multiple executors; and
in response to a state persisting event, storing, in the database, an instruction pointer indicating a segment of the computer code being executed by the interpreter.

8. The computer-implemented method of claim 7, further comprising resuming execution of the computer code after persisting the state by:
obtaining, from the database, the memory registry data, the call stack, and the instruction pointer; and
resuming execution of the computer code at the segment indicated by the instruction pointer.

9. The computer-implemented method of claim 1, further comprising:
in response to a first interaction from the client device, generating, utilizing the interpreter, a first output;
persisting a state of the interpreter corresponding to the first output; and
in response to a second interaction from the client device, generating a second output based on persisting the state of interpreter corresponding to the first output.

10. The computer-implemented method of claim 1, further comprising performing an in-function garbage collection process as part of executing the computer code.

11. A system comprising:
at least one processor; and
a non-transitory computer-readable medium storing instructions which, when executed by the at least one processor, cause the system to:
in response to a query received from a client device, generate, utilizing a context engine to interact with a large language model, computer code executable for responding to the query;
execute the computer code utilizing an interpreter integrated with the context engine and comprising swappable logic that is interchangeable across multiple executors;
generate, as part of executing the computer code utilizing the interpreter, a first context engine output by implementing the interpreter to interpret the computer code from the context engine to a first executor for testing; and
generate, as part of executing the computer code utilizing the interpreter, a second context engine output by implementing the interpreter to interpret the computer code from the context engine to a second executor for validation.

12. The system of claim 11, wherein the interpreter cannot process code expressions outside of explicitly defined types that define attributes and functions of code expressions.

13. The system of claim 11, further storing instructions which, when executed by the at least one processor, cause the system to utilize the interpreter to prevent a downstream model from one or more of performing network operations, determining contextual environment data of the first executor and the second executor, or creating new subprocesses.

14. The system of claim 11, further storing instructions, which when executed by the at least one processor cause the system to dynamically expose a type defined within the interpreter by:
exposing called data corresponding to the type as part of executing a function of the computer code that refers to the called data; and
not exposing uncalled data corresponding to the type as part of executing the function of the computer code.

15. The system of claim 11, further storing instructions, which when executed by the at least one processor cause the system to persist a state of the interpreter by:
storing, in a database during execution of the computer code, memory registry data associated with performing a function via the interpreter;
storing, in the database, a call stack comprising data defining a computer environment of an executor from among the multiple executors; and
in response to a state persisting event, storing, in the database, an instruction pointer indicating a segment of the computer code being executed by the interpreter.

16. A non-transitory computer-readable medium storing executable instructions which, when executed by at least one processor, cause the at least one processor to:
in response to a query received from a client device, generate, utilizing a context engine to interact with a large language model, computer code executable for responding to the query;
execute the computer code utilizing an interpreter integrated with the context engine and comprising explicitly defined types that define attributes and functions of code expressions and swappable logic that is interchangeable across multiple executors;
generate, as part of executing the computer code utilizing the interpreter, a first context engine output by implementing the interpreter to interpret the computer code from the context engine to a first executor; and
generate, as part of executing the computer code utilizing the interpreter, a second context engine output by implementing the interpreter to interpret the computer code from the context engine to a second executor.

17. The non-transitory computer-readable medium of claim 16, further storing instructions which, when executed by the at least one processor, cause the at least one processor to:
perform a first type checking process before runtime for executing the computer code to prevent the interpreter from accessing data outside of the explicitly defined types; and
perform a second type checking process at runtime for executing the computer code to prevent the interpreter from accessing data outside of the explicitly defined types.

18. The non-transitory computer-readable medium of claim 16, further storing instructions which, when executed by the at least one processor, cause the at least one processor to:
store, in a database during execution of the computer code, memory registry data associated with performing a function via the interpreter;
store, in the database, a call stack comprising data defining a computer environment of an executor from among the multiple executors; and
in response to a state persisting event, store, in the database, an instruction pointer indicating a segment of the computer code being executed by the interpreter.

19. The non-transitory computer-readable medium of claim 16, further storing instructions which, when executed by the at least one processor, cause the at least one processor to perform an in-function garbage collection process as part of executing the computer code.

20. The non-transitory computer-readable medium of claim 16, further storing instructions which, when executed by the at least one processor, cause the at least one processor to:
in response to a first interaction from the client device, generate, utilizing the interpreter, a first output;
persist a state of the interpreter corresponding to the first output; and
generate, utilizing the large language model, a second output based on the first output indicated by persisting the state of the interpreter.
